(19) United States
(12) Patent Application Publication
(10) Pub. No.: US 2020/0033470 A1
(43) Pub. Date: Jan. 30, 2020

(54) mm-Wave Radar Sensor for Distance Measurement in Short and Medium Range

(71) Applicant: Novelic d.o.o., 11000 Belgrade (RS)

(72) Inventors: Veselin Brankovic, Belgrade (RS); Veljko Mihajlovic, Belgrade (RS); Djordje Glavonjic, Kaludjerica (RS); Darko Tasovac, Belgrade (RS)

(73) Assignee: Novelic d.o.o., 11000 Belgrade (RS)

(21) Appl. No.: 16/541,155

(22) Filed: Aug. 15, 2019

Related U.S. Application Data
(63) Continuation-in-part of application No. 15/599,491, filed on May 19, 2017, now abandoned.

(51) Int. Cl. G01S 13/93; G01S 7/35; G01S 7/41

(52) U.S. Cl. CPC G01S 13/931; G01S 2013/9314; G01S 7/412; G01S 7/35

(57) ABSTRACT

The present invention discloses an method for mm-wave radar sensor to be deployed in the vehicles for parking sensor, as well as in industrial environments, robotics environments and other environments for addressing distance calculations from 0 cm to above 10 m.

The key system relevant components of the proposed systems are: utilization of mm-wave integrated radar SOC, supporting Frequency modulated Continues Wave (FMCW) radar operation principle and continues wave (CW) radar operations, with additional analog functionality being integrated on SOC, planar antenna structure, and specific method of operation of switching from FMCW operation mode to the CW operation mode.

Preferably, the system, being integrated as HW module with SW components is using non licensed 60 GHz or 77-79 GHz frequency band with integrated RF radar SOC with PLL, with physical size less than 2×2×0.5 cm, and it is used for moving and parking assistance, being integrated as invisible in the vehicle body.

### CROSS-REFERENCE TO RELATED APPLICATIONS

This application is a Continuation-in-Part application of pending U.S. Patent Publication No. 20180335512 A1 published Nov. 22, 2018 and Ser. No. 15/599,491 and filing date is 2017-05-19, which is hereby incorporated herein in their entireties by reference.

### DESCRIPTION

mm-Wave Radar System Apparatus and Method of Operation for simultaneous medium distance and short distance sensing.

### TECHNICAL FIELD

The present invention relates to a mm-Wave Radar Sensor apparatus concept and radar sensor operation method addressing capability to detected simultaneously medium distances larger than 10 m as well as short distances, below 20 cm.

### BACKGROUND ART

There is a strong motivation to deploy the low cost, miniature small distance sensors particularly in the following applications:
a) Distance detection of the objects inside the vehicle cabin
b) Distance detection of the objects outside of the vehicle cabin
c) Distance detection for industrial machinery in the production process
d) Distance detection for robotics, movable arms to the objects
   where the family of the applications demands the need to detect the distances covering range from zero distance up to ranges larger than 10 m.

Currently state of the art mm-wave radar systems being on the market are deploying frequency modulated continues wave (FMCW) radar concept, and they are operating in the frequency bands in 60 GHz Range (non-licensed band), 77-81 GHz automotive band, and 120 GHz band ISM band. In all cases integrated System on Chip supporting frequency modulated continues wave (FMCW) radar analog operation with or without PLL on the same die are proposed and used. These SoCs can be in many cases used for Doppler type of applications, where vibrations are detected.

Main application area for mm-wave radar sensor, currently on the market are:
Long range distance detection up to 300 m
Blind spot detection

These applications suffers in short distance detection, and due to the nature of the frequency modulated continues wave (FMCW) radar operations they cannot work for distances below 20 cm, as the obtained frequency which reflects the distance to the target is low.

In this invention we propose an apparatus for the future sensor module and it operations, being able to detect the distances in cm range level, by using other system concept than frequency modulated continues wave (FMCW) radar, based on specific continues wave (CW) mode operation.

The typical and essential application, addressed by this invention is effective calculation of the distance for parking sensor module, being able to replace ultrasound modules addresses distance sensing from 0 cm up to above 10 m, being fully integrated in the automotive enclosure, like in bumpers and fully invisible.

Continues wave (CW) radar sensing is used for vibrations or movement detection in state of art radar sensor application.

Frequency modulated continues wave (FMCW) radar sensor is used as state of art approach for distance calculation.

In this invention we are introducing using continues wave (CW) radar sensing for the distance calculation, for special case of distance detections, where the reflected object is physically large compared to the distance of sensor, being close to the sensor, in combination with frequency modulated continues wave (FMCW) radar sensor. This is possible by using introduced approximative quadratic polynomial approximation having three sets of coefficients, where the distance is calculated by detected received power level. This works in case of close proximity of the sensor, where frequency modulated continues wave (FMCW) approach has inaccuracies and it is not able to operate.

The following patents and patent applications published in last several years show the relevance of the topic and the state-of-the-art.

DE 102012201367, “The millimeter wave radar” introduces a millimeter-wave radar device with at least one millimeter wave circuit and at least one antenna, constructed as a module of a multi-layer multi-polymer board, working in frequency modulated continues wave mode (FMCW).

U.S. Pat. No. 7,782,251, “Mobile millimeter wave imaging radar system” introduces a short range complex millimeter wave imaging radar system, having scanned Tx and Rx antennae.

U.S. Pat. No. 4,929,958, “High precision radar detection system and method” describes the systems with four transducers to accurately determine the azimuth angle of a radar emitting object.

U.S. Pat. No. 8,779,969, “Radar device for detecting azimuth of target” by Denso, describes azimuth detection by analyzing echoes by spectrum performance, excited by frequency ramped signal, mixed by the excitation signal.

U.S. Pat. No. 5,657,027, “A Two dimensional interferometer array”, treats two dimensional problem approach using 4 receiving channels and specific digital processing.

U.S. Pat. No. 6,736,231, “Vehicular occupant motion detection system using radar” introduces ultrasonic radar approach for determining seat occupancy by detecting the vital signs information. Its “radar” based system has two physically separated receivers of reflected ultrasound signals, and two units for further processing.

U.S. Pat. No. 9,865,150 “Millimetre-wave seat occupation radar sensor” introduced the system for seat occupation sensing, disclosing hardware apparatus working in Doppler mode, being able to detect vibrations, by using continues wave (CW) sensing.

### SUMMARY OF INVENTION

This invention proposed apparatus 100 and method of operation for distance detection for various applications allowing detecting distances from 0 cm up to more than 10 meters.

The key system relevant components of the proposed apparatus 100 are:
Planar antenna system, realized by the plurality of the technologies, with each of the transmit 21 and receiving 22 parts having radiation diagram in the direction where the distance is to be measured.
Millimeter-wave radar with integrated front end on silicon 10, System on Chip, providing analog processing of the mm-wave signal, and the provision of the analog to digital conversion functionality, having at least one Tx chain, and at least one Rx chain, having full FMCW distance detection operation capability know from the state of art, and having
a) Analog functionality being able to detected power level approaching at least one of the Rx chain before approaching mixing functionality, by using plurality of realization options
b) Functionality to after obtaining the control interrupt switch from FMCW mode operation to the pure CW operation, using specific frequency within its frequency operation capability.
Digital signal processing functionality 40, having standardized physical digital interface 60, with plurality of the realization;

The proposed system combines operation in frequency modulated continues wave (FMCW) and continues wave (CW) Mode. In the state of art non-military radar sensors for distance detection in automotive field FMCW operation mode is used. This operation mode is especially used and widely deployed for the long range radar automotive system, covering the distances in the 300 m range. There is a strong attempt to used existing long range SoC RF functionalities for detecting distances below 20 cm. This is however hardly possible using frequency modulated continues wave (FMCW) operation mode.

In this innovation we are proposing, changing functional topology of the frequency modulated continues wave (FMCW) analog part with specific analog functionality, and introducing the new operation mode, where FMCW radar operation is switched off to the single frequency continues wave (CW) operations. The complete system observes the detected distances by frequency modulated continues wave (FMCW) operation and incoming power on at least one Rx input in RF SOC. After specific threshold distance L, is achieved, the complete Apparatus 100, is switching to the single frequency CW operation mode. That means the millimeter-wave radar with integrated front end on silicon 10, System on Chip, does not produce frequency ramps, it is starting to produce radiation on only one frequency. The threshold distance 1 is chosen after empirical evaluation of the sensor application scenario, which imposes the position of the sensor in the vehicle environment, and vehicle environment.

For example in automotive related preferable application for the proposed invention for parking assistance, the aim is to replace the commonly used ultra sound systems by miniature and low cost radar sensors. Radar sensor are integrated in the bumper, or integrated in the lighting systems or in the automotive enclosure. Tx and Rx antennas of the radar system are having specific radiation diagrams. The specific threshold distance 1 can be set to the value lower than 20 cm, meaning that for distances below 20 cm, the distance is calculated by using primarily set of the polynomial coefficients in the polynomial equations having as unknown information the power of the signal being detected on the Rx input inside of the entity 10, where CW mode is active. The set of the polynomial coefficients are preset by the empirical evaluation of the sensor position and it's actual application. The numbers of the polynomial coefficients are chosen to be minimal by respecting calculation effort from one side and tolerances in mechanical enclosures, which are influencing accuracy just in case as the accuracy in RX power level acquisition. They typical application solution for parking sensor, aiming replacement of the ultrasound systems is proposed, by prosing 2N radiation elements antenna, where N can takes values from 1, 2, 4 or 8, being chosen to provide in elevation area narrow beam to minimize the reflections from driving surface, and in the same time to have wide angle range in azimuth, being explicitly wider as in elevation.

The digital part typically includes CAN and/or LIN interface allowing easy connection to the vehicle infrastructure. The means of short range wireless connection to the vehicle system 63 is optional and suited for the aftermarket usage. In aftermarket mode the proposed apparatus may have integrated audio and/or visual indicators.

### BRIEF DESCRIPTION OF DRAWINGS

FIG. 1 presents general application parking scenario, where the sensors measure distance to one object by state of the art frequency modulated continues wave (FMCW) operation mode, and when the measured distance is below specific small threshold distance L Switch, measured by using proposed innovative approach switch to simple continues (CW) mode sending only one frequency. L switch value in figure corresponds to distance threshold value 1.

FIG. 2 presents the real case in parking, when the obstacle object is very close to the radar sensor, for the case of the metal surface, and for the case of the metallic cylinder.

FIG. 3 presents the proposed hardware (HW) topology of the Apparatus 100, with its functional entities, hereby the besides state of the art frequency modulated continues wave (FMCW) entities in the mm-wave SOC 10, new entity 70, “coupling and power detection” is introduced. Further new functional entity 80: “switching mode functionality” in the controlling part of the digital signal processing functionality is introduced.

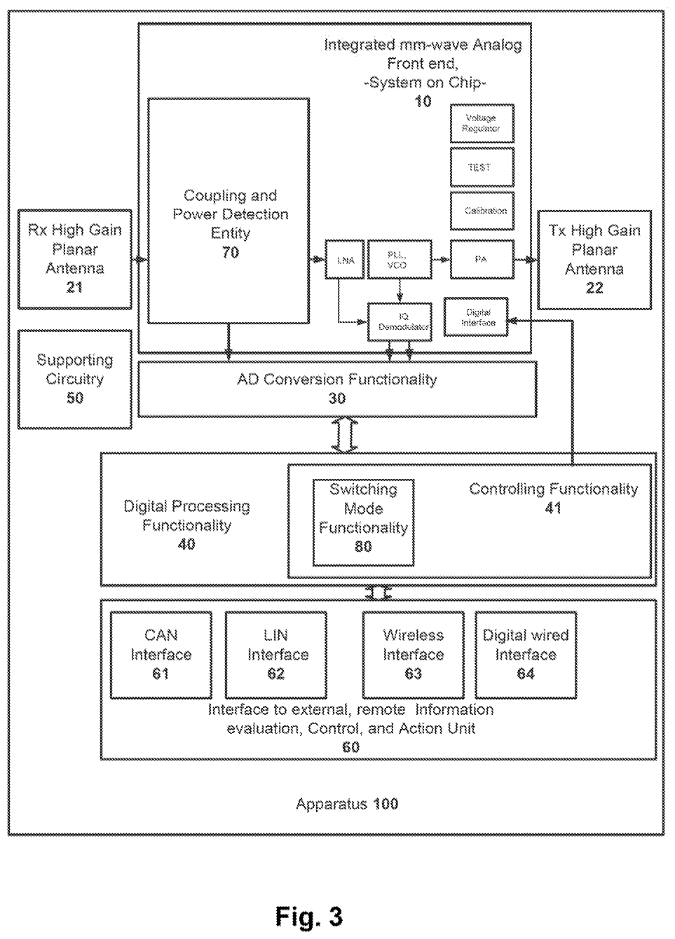

FIG. 4 presents entity 70 and its two sub parts coupling entity 71 and power detection entity 72.

FIG. 5 presents method of operation principle diagram of switching from frequency modulated continues wave (FMCW) mode to single frequency continues (CW) Mode of the proposed mm-wave radar based distance sensor. L switch value in figure corresponds to distance threshold value 1.

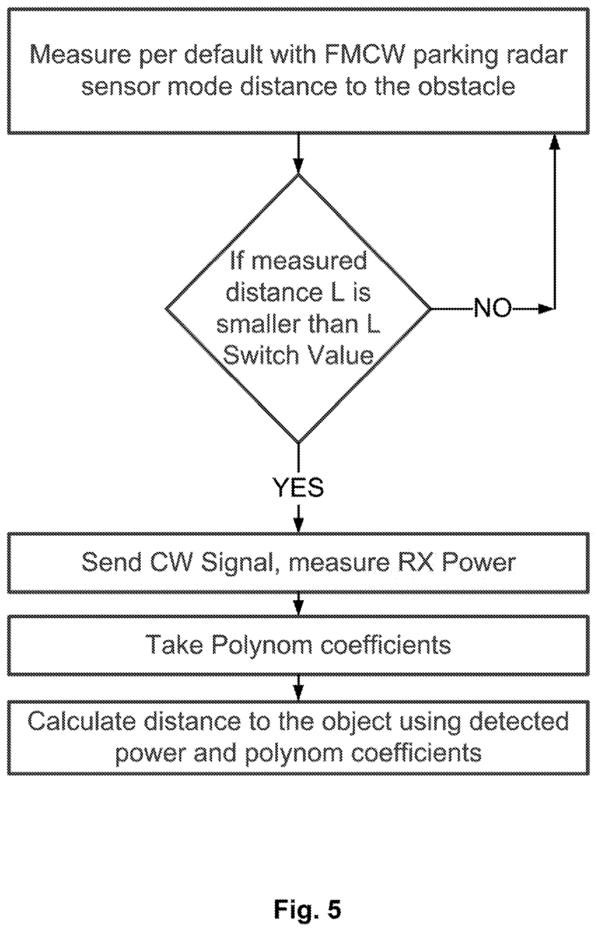

FIG. 6 presents top view of the proposed preferred embodiment Apparatus 100 realization: A) having 4 dipoles with vertical polarization from Rx and Tx antenna systems as well as B) having 4 dipoles with horizontal polarization for Rx and Tx antenna systems

### DESCRIPTION OF EMBODIMENTS

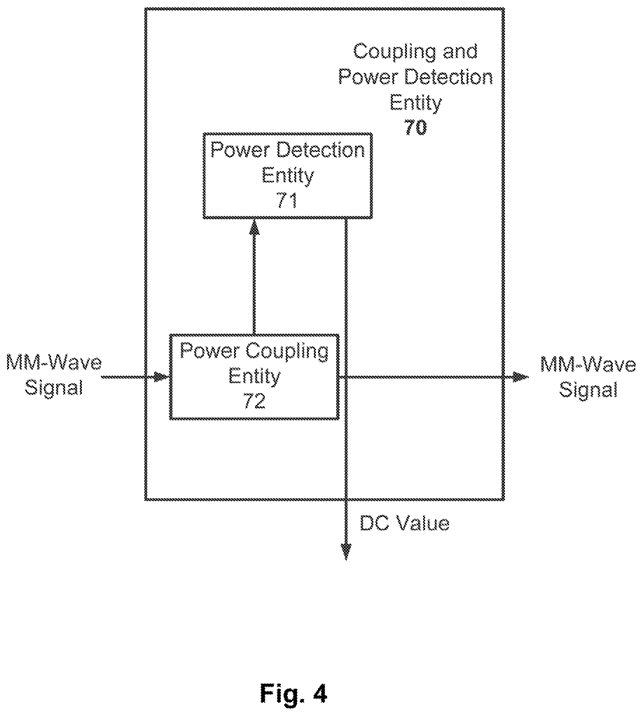

Apparatus 100 is preferably integrated in the vehicle bumper being invisible, having line-of-sight towards the possible obstacles, in front of bumper. The basic generalized purpose of the proposed innovative approach is to provide the measurements of the distance from the sensor to the object. In proposed hardware (HW) topology of the integrated mm-wave SOC, we are proposing introduction of the entity 70 addressing RF power coupling and RF power detecting, being realized by the plurality of the realization active and passive circuit topologies directly on the integrated RF IC SOC 10. The detail of the Entity 70, is shown in the FIG. 4 introducing entity 71 and entity 72. Entity 72 is coupling very small part of the Incoming power, from receive antenna 22 and providing it to the entity 72, where the RF part is passing to the LNA structure and further to IQ demodulator. Due to the integration of the apparatus 100 in the vehicle for example, we have losses in the irradiated power and also if we are aiming to detected object far away, we would need to handle very small RF signal approaching entity 70, and if we would couple a lot of energy we will further influence the radar sensor sensitivity and maximum range to be achieved. Therefore, the coupling level is realized to be between 20 and 60 dB, meaning that the detection sensitivity of the power detection entity 72, may be achieved, only if very high RF signal level on the RX antenna 22 is present. On the other hand we have large RF signal level on RX antenna only if the object is very close to the sensor, and the reflections are very high. With this HW approach on the integrated RF IC, being released by the plurality of the topologies we are ensuring that the power detection entity 72, is detecting RF signals only if the object is very close to the sensor apparatus 100, and then as a results of the analog power detection a DC value is sent to the signal processing entity 40, after digitalization in the entity 30. This DC value is proportional to the power being on the RX antenna input. Practical realization of the coupling from the Rx input after antenna on the SOC itself, may be realized by the different means of passive coupling, which may be inherently related to the applied semiconductor technology.

The state of art automotive frequency modulated continues wave (FMCW) radar sensor, which are realized in 77-81 GHz and which are addressing long range ADAS application, may work as close as 20-30 cm to the object. The minimum detection distance is related to the several constrains: frequency modulated continues wave (FMCW) principle, scattering performance of the objects which are highly complex, where the distance to the object is close to the object dimensions, and system noise, due to small beat frequency. On the other hand parking sensor applications required the distance measurements below 30 cm ideally up to 1-2 cm distance, with accuracy of 1-2 cm.

In this invention we are introducing using continues wave (CW) radar sensing for the distance calculation, for special case of distance detections, where the reflected object is physically large compared to the distance of sensor, being close to the sensor, in combination with frequency modulated continues wave (FMCW) radar sensor. This is possible by using introduced approximative quadratic polynomial approximation having three sets of coefficients, where the distance is calculated by detected received power level. This works in case of close proximity of the sensor, where frequency modulated continues wave (FMCW) approach has inaccuracies and it is not able to operate.

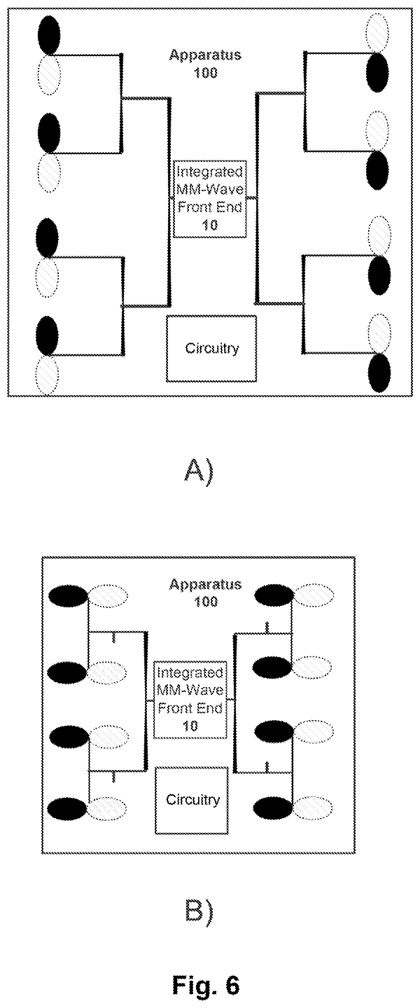

Let us observe following parking sensor application case, being related to the preferable Apparatus embodiment presented in the FIG. 6:

G1 [dBi] TX Antenna Gain inside bumper: 12
G2 [dBi]: RX Antenna Gain inside bumper 12

### f [GHz]: 60

RAT [dB]: Losses 7 dB in bumper one way 7
P1 [dBm]: Power fed to Tx antenna after connection losses 8

We are noticing that the EIRP in above case is complying with ISM Band a worldwide regulation EIRP limits for 57-64 GHz operations.

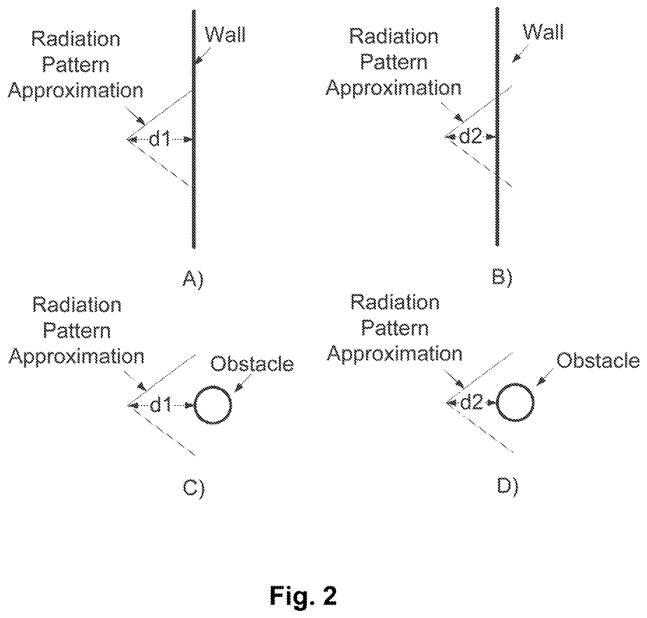

And let us have a typical parking application case where another vehicle, or parking facility wall is close to bumper at 20 cm or less, as it is show in FIG. 2a, and FIG. 2b. In that case we may notice that theoretically almost the whole power irradiated are reflected and sent to RX antenna systems, if the reflecting surface area is infinitely large. We may also notice that, when we are very close to the antenna with large object the complete irradiated power of the antenna beam is reflected. So radar equation is not valid, and we may see that in theoretical case we have a direct mapping between the received power and distance from the antenna to the object. More precise, the behavior of the function is close to the quadrature behavior, which means that with power detection dynamic range of 30 dB we may cope with 30 cm to 1 cm distance detection. Also we have here the physical law that shows that as long as we are near to the radar sensor the ideal reflection is more reals and we have more accurate results. Related coupling can be on more than 30 dB level, so that power detector is starting detecting power levels from ˜70 to ˜80 dBm, up to ˜40 dBm to −50 dBm for example. By using specific high dynamic range power detection topology for power detection entity, being released directly on chip 10, more accuracy in mapping distance to power level may be achieved. By observing FIG. 2c and FIG. 2d, we are observing metallic cylinder obstacle close to the sensor. By observing the figures, it may be intuitively concluded that the receive power level in the comparison with wall will be lower, because part of the radar signals from the antenna beam edges are not scattered in the direction of antenna or they are passing close to the obstacles. On other side as much as obstacle is closer to the sensor the system starts to behave as a reflection from the infinitive size metal area, which behaves as quadrature dependence between distance and detected RF power.

Having this in mind we are introducing quadratic polynomial function with three coefficients, which relates detected power at receiver antenna (Prx) and distance to the target (R)

R=f(Prx)

This function maps as a close practical approximation the RX power to the detected distance in the following way:

R=A(PRx)\hat{ }(½)+B(PRx)\hat{ }(¼)+C

R— distance
Prx=power at the receiving antenna
A,B,C—calculated coefficients to get the distance calculated.

The Distance threshold value 1, is the distance when the system decides to switch from frequency modulated continues wave (FMCW) operation to continues wave (CW) operation.

The Distance threshold value 1 is less than 20 cm from the object.

By getting in the detection range closer to 20 cm frequency modulated continues wave (FMCW) calculating principle is getting the problems in accuracy, not being able to calculate the distance, due to the nature of the principle and imperfections of the hardware. On other side by calculation of the distance by detected power, we have an opposite situation, as much as we are close to the object the polynomial calculation is more accurate.

So the methodology for setting distance threshold value 1, can be set to be somewhere between the 5 and 10 cm practically, preferably at 7.5 cm, from the radar sensor surface.

The polynomial coefficients are set after 3D electromagnetic simulations for specific bumper, material, specific vehicle, and specific antenna are conducted, for the set of the key, for practical application relevant, use cases, and they are dependent from the position of the radar sensor inside of the bumper, where the physical distance from the bumper to the object is smaller than actual distance from radar sensor antennas to the object.

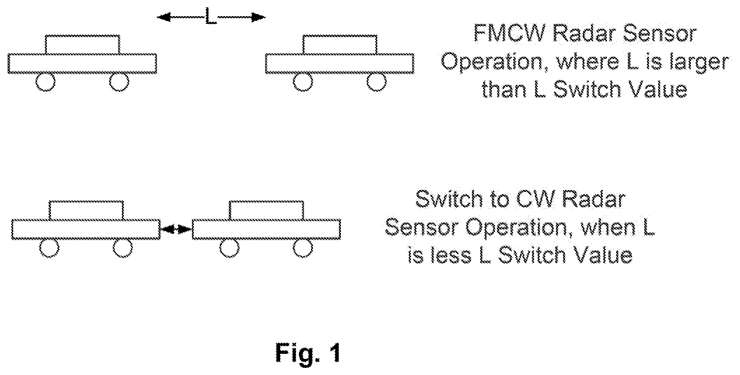

The set of values A, B and C are considered to be fixed for use case in FIG. 1 application scenario, or FIG. 2a) and FIG. 2b) case. Those cases are the most common one, where the parking toward the wall, like in garage, or parking toward the front of the already parked vehicle is approached.

The cases described in FIG. 2c) and FIG. 2d) are recognized by the system. Namely by approaching set distance threshold value 1, by using continues wave (CW) methodology, the power level is calculated. This power level is compared with predefined power level, expected for the case when the infinite metal wall, being equal to the wall of garage, is present. Depending of the power level differences, the different set of A, B and C coefficient from look up table is used for the calculation of the distances, being lower than distance threshold value 1.

For example, at the distance threshold value 1 of 7.5 cm in case of parked vehicle in front of sensor, or garage wall we have a detected power level P1. By using frequency modulated continues wave (FMCW) method we know there is object at 7.5 cm, but we are detecting received power level P2, which is smaller at that detected power level P1. The system concludes that rod, or cylinder or object with small effective reflection surface is in front of sensor. If the receiver senses P2 value is ¼, or ½ or ¾ less than P1 range, the system is using 4 different sets of A, B, C parameters, for distance calculation in less than 7.5 cm distance. In this particular practical case, each sensor is using 4 different sets of 3 coefficients of the quadratic equations to calculate the distance top the object depending of the received power level. Those 12 coefficients are pre-stored in the sensor, depending on car model, assembly and position of the sensor and they are determined by 3D electromagnetic calculation, or empirical measurements of the received powers for specific sets of the objects.

These coefficients are that in the process of the empirical tuning for each specific vehicles fine-tuned, and provided for the each sensor look up table.

Taking into account proposed 60 GHz ISM band operation, or alternatively 77-79 GHz operation, and 4×antenna elements for 21 and 22, the approximate size of the device may be less than 2×2×0.5 cm, which would inherently allow practical use and integration capability in vehicles or in the industrial embodiment.

The entity 10 is preferably realized using SiGe BiCMOS technology that provides high performance. Alternatively CMOS technology may be used.

AD (analog to digital) conversion functionality 30 converts the analog conditioned signal or two quadrature signals, I and Q, of the entity 10, and feeds digital representation of signal or signals to the Digital processing functionality 40 for further processing. Entity 30 is realized by plurality of the realization options, with sampling frequency typically under 1 MHz and typically at least 8 bit resolution. Entity 30 may be integrated on the same chip as Entity 10. Entity 30 may be integrated on the same chip as Entity 40. Entities 40, 10, and 30 may be all integrated on a single chip. Entity 60 is providing interface to vehicle infrastructure by using typical vehicle wired interfaces like CAN interface 61, and/or UN interface 62, optional custom digital interface 64, and optional short range wireless interface 63. Standard interface, preferably CAN, is obligatory for all applications where the apparatus is integrated in vehicle during manufacturing. For aftermarket applications the short range wireless interface, preferable Bluetooth, may be integrated in entity 60. Supporting circuitry 50 optionally includes additional memory, manual switching, power supply regulation circuitry, mechanical support, and any additional functionality required for easy integration, during manufacturing or later in aftermarket. The mechanical support structure for integration of all functionality is preferably provided using advanced polymer technologies. Optionally, in case of the aftermarket operation, entity 50 may also include battery, loudspeaker or warning light sources, allowing autonomous operation.

Digital processing functionality 40 may be realized by the plurality of technologies, such as: advanced CPUs, FPGAs, advanced μC, DSP, or ASIC, or their combinations, where the digital processing may be performed by “soft” approach or by hard-wired approach or by their combination. Preferably functionalities 60 and 40 are integrated on a simple ASIC, having CPU on one digital SOC. Digital processing functionality 40 includes functionalities 41.

In FIG. 6 two antenna preferable high-gain arrangements in the scope of the apparatus 100 top view are shown. On the left side we have vertical polarization 4 dipoles environment for Rx and Tx antenna respectively. In this arrangement we would like to achieve in the elevation small angle and wider angle in azimuth. On the left side we see the similar arrangement with horizontal polarization. It may be observed that horizontal arrangements requires lower size of the module, but on other side unwanted clutters may be larger.

The Tx and Rx antenna systems are preferably realized as the planar printed dipoles with ellipsoid-like antenna shapes, with the two parts printed on opposite sides of the dielectric layer, which also provides mechanical support. Prints on the opposite side of the dielectric area are depicted using dashed lines. Preferred antenna elements are fed by symmetrical strip lines. On the bottom of the Apparatus 100 the metalized reflector is introduced allowing radiation perpendicular to the printed antenna area. Symmetrical strip line may be advantageously connected to differential mm-wave inputs and outputs of the entity 10 by using metalized micro-vias produced by advanced polymer technology.

As preferred embodiment realization solution proposed Apparatus 100 is realized using polymer technology, without PCB structures.

1: A method of operation of MM-wave Parking Sensor Apparatus 100, where the method of operation includes:
Calculating the distance using between Parking Sensor Apparatus 100 and obstacle, by state of the art frequency modulated continues wave radar (FMCW) radar detection principles until the distances being equal and greater to the distance threshold value 1, which is preset for each specific vehicle and position of the apparatus 100 within the vehicle, for the distance measurements, and being less than 10 cm, then
switching to the continues (CW) radar operation mode by approaching distance level calculation in the distance range below distance threshold value 1, by measuring the DC value, being related to the detected Power level by illuminating obstacle by continues (CW) radiation, on at least one of RX chains of the Apparatus 100, then
comparing detected DC value, being related to the detected Power level by illuminating obstacle by continues (CW) radiation, with preset DC value, being related to the detected Power level by illuminating obstacle by continues (CW) radiation, when the obstacle is metal surface at the distance threshold value 1, having in both dimensions at least twice size as distance threshold value 1, than
using preset look up table, labeling ratio of detected power level, with preset power level in case of said metal surface, and depending on the said ratio, selecting three coefficients, then
calculating the distance of the object to the sensor by the quadratic equation, for the distances below distance threshold value 1, using said selected three coefficients, where
MM-wave Sensor Apparatus 100, is defined as a mm-wave parking sensor Apparatus 100, where mm-wave declares operation between 30 and 300 GHz, including: planar antenna for transmitting mm-wave radio signals 22, where a high-gain planar antenna has at least two radiation elements; planar antenna for receiving mm-wave radio signals 21, where a high-gain planar antenna has at least two radiation elements; an integrated mm-wave radio front end 10, implemented in arbitrary semiconductor technology, having on-chip integrated mm-wave voltage control oscillator, mm-wave power amplifier, mm-wave low noise amplifier, mm-wave down conversion mixer, digital control interface, power supply; and PLL, being able to provide frequency modulated continues wave radar (FMCW) operations and continues wave (CW) TX operation, having additionally coupling and power detection entity 70, which has power detection functionality, being able to measure continues wave (CW) power level, being received an at least one of possibly more antenna Rx inputs.
